(19) United States
(12) Patent Application Publication
(10) Pub. No.: US 2023/0138369 A1
(43) Pub. Date: May 4, 2023

(54) DEVICE AND SYSTEM FOR ALERTING VEHICLES OF APPROACHING EMERGENCY VEHICLE

(71) Applicant: Darryl Eugene Watkins, Louisville, KY (US)

(72) Inventor: Darryl Eugene Watkins, Louisville, KY (US)

(21) Appl. No.: 17/811,361

(22) Filed: Jul. 8, 2022

Related U.S. Application Data
(60) Provisional application No. 63/263,195, filed on Oct. 28, 2021.

(51) Int. Cl. B60W 50/14; B60K 35/00; H04W 4/46; H04W 4/90

(52) U.S. Cl. CPC B60W 50/14; B60K 35/00; H04W 4/46; H04W 4/90; B60W 2050/146; B60W 2556/60; B60W 2556/65; B60K 2370/139; B60K 2370/178; B60K 2370/1868; B60K 2370/193; B60K 2370/589

(57) ABSTRACT

Systems, methods, and computer program products for alerting non-emergency vehicles of a nearby emergency vehicle. In general, an emergency vehicle is provided that includes a first transmitter designed to transmit information, a first receiver designed to receive information, and an emergency alert system. A non-emergency vehicle is provided that includes a second transmitter designed to transmit information, a second receiver designed to receive information, and a dash cluster comprising a user interface. In use, the emergency alert system is activated, and it is determined whether the non-emergency vehicle is within a pre-determined distance of the emergency vehicle. If the nonemergency vehicle is within the predetermined distance, a dash alert is displayed on the user interface that indicates the emergency vehicle is nearby.

### CROSS-REFERENCE TO RELATED APPLICATION

This application claims the benefit of priority of U.S. provisional application No. 63/263,195, filed Oct. 28, 2021, the contents of which are herein incorporated by reference.

### BACKGROUND OF THE INVENTION

The present invention relates to vehicle safety alerts and, more particularly, to an integrated circuit capable of alerting non-emergency vehicles of approaching emergency vehicles.

Currently, there is no way for an operator driving a non-emergency vehicle to know if an emergency vehicle is approaching besides watching for flashing lights and/or listening for noise emanating from the emergency vehicle. Emergency vehicles typically travel at fast speeds when traveling to and from emergency situations. As such, they are more prone to collisions with unaware vehicle operators than other non-emergency vehicles.

As can be seen, there is a need for a device and system for alerting a vehicle operator of an approaching emergency vehicle.

### SUMMARY OF THE INVENTION

In one aspect of the present invention, a method is disclosed that includes the steps of: providing an emergency vehicle that comprises: a first transmitter configured to transmit information; a first receiver configured to receive information; an emergency alert system; providing a non-emergency vehicle that comprises: a second transmitter configured to transmit information; a second receiver configured to receive information; a dash cluster comprising a user interface; activating the emergency alert system; determining whether the non-emergency vehicle is within a pre-determined distance of the emergency vehicle; and if the non-emergency vehicle is within the predetermined distance, displaying a dash alert on the user interface that indicates the emergency vehicle is nearby.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a schematic view of an embodiment of the present invention;

FIG. 2 is a flow chart of the embodiment of the present invention; and

FIG. 3 is a system view of the embodiment of the present invention, showing the communication between an emergency vehicle and a non-emergency vehicle.

### DETAILED DESCRIPTION OF THE INVENTION

With this overview in mind, and turning now to a more detailed discussion in conjunction with the attached figures, the techniques of the present disclosure are illustrated as being implemented in a computing device such as a PC, laptop, tablet, smartphone or other device capable of executing computer-executed instructions stored on a non-transient medium, e.g., memory, such as RAM, ROM, EPROM, flash memory and so on. Thus, the execution of steps in a process flow is by way of computer-execution of such steps, e.g., via a processor configured to retrieve the corresponding instructions from memory and execute them.

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

The following detailed description is of the best currently contemplated modes of carrying out exemplary embodiments of the present invention. The description is not to be taken in a limiting sense but is made merely for the purpose of illustrating the general principles of the present invention, since the scope of the present invention is best defined by the appended claims.

Broadly, an embodiment of the present invention provides a device and system for alerting a non-emergency vehicle of an approaching emergency vehicle. A vehicle in accordance with the present invention may include at least one computer operably coupled to a user interface. The computer may include at least one processing unit coupled to a form of memory. The computer may include, but is not limited to, a microprocessor installed in a vehicle. The computer includes a program product including a machine-readable program code for causing, when executed, the computer to perform steps. The program product may include systemic software which may either be loaded onto the computer or accessed by the computer. The loaded systemic software may include an application installed in vehicles. The present invention includes an alert that signals the non-emergency vehicle operator of an approaching emergency vehicle, giving the operator ample time to move over safely and can save lives.

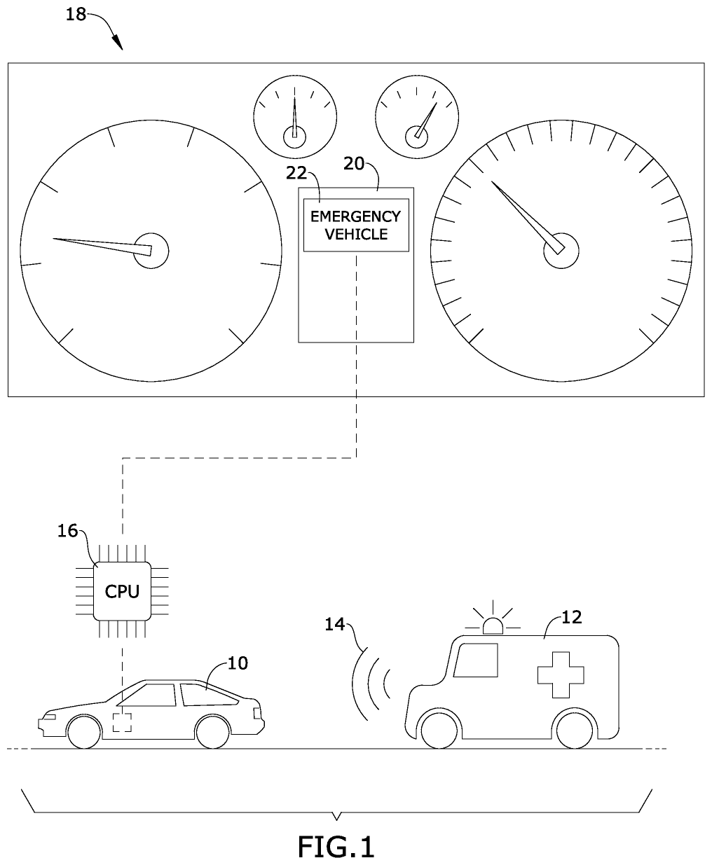

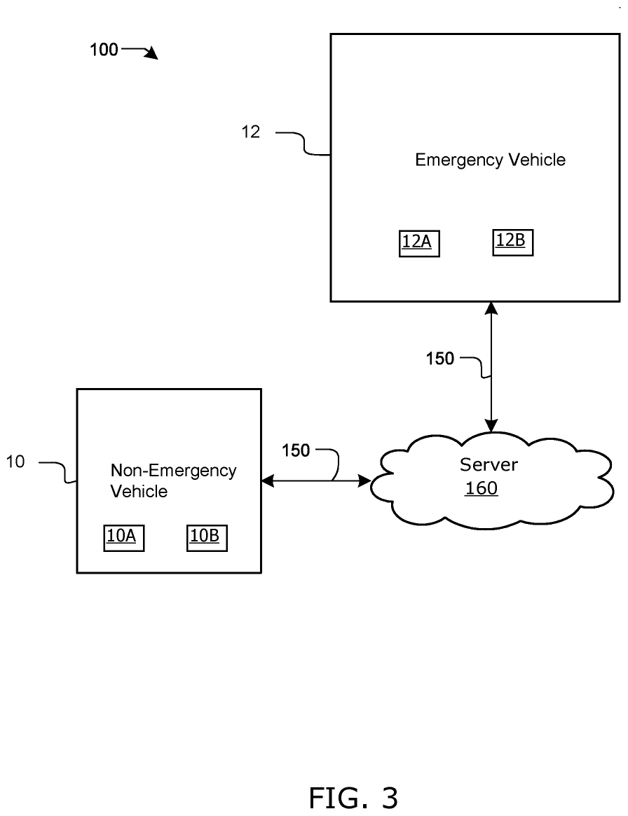

Referring now to FIGS. 1-3, in order to achieve the goals described above, provided herein are system 100, method and/or computer program product embodiments, and/or combinations and sub-combinations thereof, for alerting an non-emergency vehicle 10 of an approaching emergency vehicle 12. As part of an overall alert system 100, a non-emergency vehicle 10 communicates with an emergency vehicle 12 over a network 150. The network 150 may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, or any combination thereof. This network communication 150 may occur when the emergency vehicle 12 has activated its emergency alert system (e.g., a siren signal 14), and may utilize any appropriate transmitter 10A, 12A and receiver 10B, 12B hardware such that the emergency vehicle 12 is capable of communicating a signal to the non-emergency vehicle 10 (also described in greater detail below).

The non-emergency vehicle 10 includes a central processing unit (CPU) 16 that, when a signal from the emergency vehicle 12 is received, is capable of activating a user interface 20. The processor 16 may be programmed to execute instructions as described herein. This user interface 20 may be embodied as a dash information center 20 on a dash cluster 18, upon which a dash alert 22 flashes when the emergency vehicle is nearby and its emergency alert system is activated. Rather than the dash cluster 18, those with skill in the art will appreciate that other regions of the vehicle 10 may employ (in addition to or alternatively) this alert 22, such as, but not limited to, a console of a vehicle.

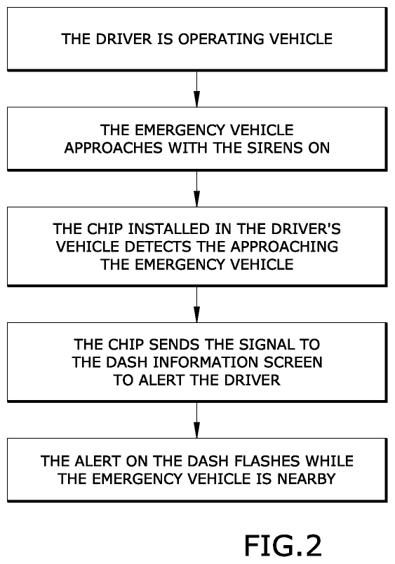

The present invention may be installed on all non-emergency and emergency vehicles to allow for communication between emergency vehicles and all non-emergency vehicles on the road to enhance safety for all drivers. In use, as demonstrated by FIG. 2, a driver operates a vehicle 10. An emergency vehicle 12 activates its emergency system (e.g., sirens 14). The driver's vehicle 10, if within a predetermined distance from the emergency vehicle 12, receives data from the emergency vehicle 12 indicating that the driver/operator should be alerted to the approach of the emergency vehicle 12. By way of example, this predetermined distance may be 200 feet (i.e., any vehicle within a 200 feet radius of the emergency vehicle will receive the notification). Accordingly, the CPU 16 signals the dashboard information center 20 to display the alert 22, thus indicating to the driver that the emergency vehicle 12 is approaching.

The present invention may be implemented in the following exemplary manner. GPS may be used to determine/indicate the position of the vehicles 10, 12. The GPS locations may be determined by GPS modules installed in the vehicles 10, 12 and transmitted over the network 150 and stored on a server 160. While most vehicles currently are manufactured with technology capable of communicating with servers, for vehicles that do not have this capability, a third party media server may be installed. The server 160 is configured in such a way that it is capable of implementing the above-described functionality (e.g., determining distances between vehicles 10, 12, to determine if an alert 22 should be displayed in a particular vehicle 10 or not.

The present disclosure envisions any suitable number of computing systems (e.g., the CPU 16) to implement the above-discussed system 100. It also contemplates the computing system 100 taking any appropriate physical form to achieve the end results discussed above (i.e., alerting a driver of an approaching emergency vehicle 14). Where appropriate, the computing system may include one or more computing systems; be unified or distributed; be provided in multiple locations (e.g., respective computing systems being provided in both the emergency vehicle 12 and the non-emergency vehicle 10); be provided across a plurality of machines; be provided across a plurality of data centers; or reside in a cloud (e.g., the network communication between vehicles 10, 12 first passes through a cloud server 160 before being transmitted to the other vehicle(s) 10, 12), which may include at least one cloud component in at least one network. Where appropriate, one or more computing systems may perform without substantial temporal or spatial limitation at least one step of one or more methods/processes detailed herein.

In certain embodiments, the computing system(s) includes a processor, memory, storage, an input/output (I/O) interface, a communication interface, and a bus. The present disclosure contemplates any suitable computer system having any suitable number of any suitable components in any suitable arrangement. In certain embodiments, processor includes hardware for executing instructions, such as those that define a computer program, and the present disclosure envisions use of any processor suitable to perform the functions discussed. In certain embodiments, memory includes main memory for storing processor instructions for execution or data for processor to operate on, and the present disclosure envisions any suitable memory. In certain embodiments, storage includes mass storage for data or instructions, and the present disclosure envisions any suitable storage. In certain embodiments, I/O interface includes software, hardware, or both, providing one or more interfaces for communication between computing system 200 and one or more I/O devices. Computing system(s) may include one or more of these I/O devices, where appropriate. One or more of these I/O devices may facilitate communication between a computing system and a user (e.g., the dash information center 20). The present disclosure envisions any suitable I/O interface. In certain embodiments, communication interface includes software, hardware, or both providing one or more interfaces for communication between computing system and one or more other computing systems or one or more networks 150. The present disclosure envisions any appropriate network 150 (e.g., a wireless or wired network) and any appropriate communication interface for it. In certain embodiments, bus includes software, hardware, or both coupling components of computing system to each other, and this disclosure contemplates any appropriate bus (or other form of interconnection).

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

What is claimed is:

1. A method comprising:
providing an emergency vehicle that comprises:
a first transmitter configured to transmit information;
a first receiver configured to receive information;
an emergency alert system;
providing a non-emergency vehicle that comprises:
a second transmitter configured to transmit information;
a second receiver configured to receive information;
a dash cluster comprising a user interface;
activating the emergency alert system;
determining whether the non-emergency vehicle is within a pre-determined distance of the emergency vehicle; and
if the non-emergency vehicle is within the predetermined distance, displaying a dash alert on the user interface that indicates the emergency vehicle is nearby.

2. The method of claim 1, wherein the first transmitter and the second transmitter transmit information to a server over a network, and the first receiver and the second receiver receive information from the server over the network.

3. The method of claim 2, wherein the information comprises location data of the non-emergency vehicle and location data of the emergency vehicle.

4. The method of claim 3, wherein the location data of the non-emergency vehicle is determined by a non-emergency vehicle GPS module and the location data of the emergency vehicle is determined by a emergency vehicle GPS module.
